(19) United States
(12) Patent Application Publication
(10) Pub. No.: US 2009/0152762 A1
(43) Pub. Date: Jun. 18, 2009

(54) METHOD AND DEVICE FOR MELT SPINNING AND DEPOSITING SYNTHETIC FILAMENTS INTO A NON-WOVEN MATERIAL

(75) Inventors: Henning Rave, Achterwehr (DE); Hans-Holger Heesch, Neumunster (DE)

Correspondence Address: BAINWOOD HUANG & ASSOCIATES LLC, 2 CONNECTOR ROAD, WESTBOROUGH, MA, 01581, US

(73) Assignee: Oerlikon Textile GmbH & Co. KG, Remscheid (DE)

(21) Appl. No.: 12/339,390

(22) Filed: Dec. 19, 2008

Related U.S. Application Data
(63) Continuation of application No. PCT/EP2007/005798, filed on Jun. 29, 2007.

(30) Foreign Application Priority Data
Jul. 1, 2006 (DE) 10 2006 030 482.9

(51) Int. Cl. D04H 3/02; B29C 47/08

(52) U.S. Cl. 264/211.1; 425/516; 425/506

(57) ABSTRACT

A method and a device for melt spinning and depositing synthetic filaments into a nonwoven material are described. The synthetic filaments are extruded and pulled off here simultaneously next to one another in several filament groups and deposited jointly on a belt. Taking into consideration a later final processing of the nonwoven material, the filaments of the filament groups are deposited next to one another to form separate filament webs which are guided next to and parallel to one another. Narrower nonwoven webs can be produced even from very large production widths. For this purpose, the extrusion means and the pull-off means are disposed above the belt in such a manner that the filaments of the filament groups can be laid to form separate nonwoven webs.

### CROSS REFERENCE TO RELATED APPLICATIONS

This patent application is a Continuation of International Patent Application No. PCT/EP2007/005798 filed on Jun. 29, 2007, entitled, “METHOD AND DEVICE FOR MELT SPINNING AND DEPOSITING SYNTHETIC FILAMENTS INTO A NON-WOVEN MATERIAL”, the contents and teachings of which are hereby incorporated by reference in their entirety.

### FIELD OF INVENTION

Embodiments of the invention relate to methods and apparatus for melt spinning and depositing synthetic filaments into a non-woven material.

### BACKGROUND

In order to produce non-woven materials, it is known that a plurality of synthetic filaments are extruded from a polymer melt, which are deposited into the non-woven material on a deposit belt after cooling by means of a drawing means. For this purpose the filaments are created by means of extrusion means substantially containing an arrangement of nozzle bores in a row such that the filaments are produced as a curtain, and are deposited on the deposit belt.

It is further known to produce the non-woven material in a non-woven web that is as wide as possible in order to obtain a high production output. A method and a device for melt spinning and depositing synthetic filaments is known, for example, from DE 25 32 900 A1, wherein the synthetic filaments are simultaneously extruded and pulled off next to each other in multiple filament groups by mean of multiple extrusion means that are arranged next to each other. A spreading of the individual filaments of the filament groups is carried out before depositing such that a wide non-woven web is obtained on the deposit belt. In this manner the non-woven material can the produced in a web at a production width of up to 10 m.

### SUMMARY

However, such large production widths require respective treatment units for after-treatment, such as calenders or winding units, in which the non-woven web must be treated in the entire production width thereof. The treatment units must therefore be stabilized accordingly at a greater expense with regard to technical equipment in order to, for example, counteract a bending of the roller extending across the entire production width. Furthermore, the spreading of the filament groups leads to more or less pronounced differences in thickness in the non-woven web. Irregularities in the deposit are unavoidable, particularly in the overlapping regions of adjoining filament groups. When reinforcing the non-woven material, irregularities in the non-woven web cannot be excluded due to the differences in thickness.

Accordingly, an object is to further improve a method for melt spinning and depositing synthetic filaments into a non-woven material and a device for carrying out the method such that the non-woven material can be produced at a production output that is as large as possible, and such that the same can be uniformly treated in the after-treatment step.

Another aim is to configure the method for melt spinning and depositing synthetic filaments into a non-woven material and the device for carrying out the method such that a production of the non-woven material that is as flexible as possible, even at high a production output, is possible.

Certain embodiments are based on the knowledge that the non-woven webs produced are largely cut into so-called usables before final processing. The width of the usables is usually substantially below the production width of the non-woven web. Non-woven webs can be produced by means of the method according to certain embodiments of the invention and by means of the device according to certain embodiments of the invention, which have a production width that is coordinated with the future usables width. For this purpose the filaments of the filament groups are deposited next to each other in separate non-woven webs, and the non-woven webs are guided parallel next to each other. The non-woven material is therefore advantageously formed by multiple non-woven webs that are received and guided parallel next to each other on the deposit belt. As a function of the extrusion means, non-woven webs can be produced at equal production widths, or each having different production widths. For this purpose, two, three, or even more non-woven webs can be deposited and guided parallel next to each other on the deposit belt, wherein a total production width of the system of 10 m or more can be utilized.

In order to avoid that the edge zones of the individual non-woven webs, and particularly the protruding fibers, get tangled with adjoining non-woven webs, a distance between the non-woven webs is maintained according to an advantageous further improvement of the method such that a gap is created between the non-woven webs on the surface of the deposit belt.

It has been shown that the productivity during the production of a non-woven material is most favorable, if the production width of the individual non-woven webs exceeds a minimum size. According to an advantageous further improvement the deposit of the filaments is adjusted such that the non-woven web placed through a filament group on the deposit belt takes up a production width in the range of 2 m to a maximum of 6 m.

The after-treatment of the non-woven web can be carried out collectively or separately as a function of the number of non-woven webs, and as a function of the entire production width on the deposit belt. In a case of a collective after-treatment, the non-woven webs are discharged from the deposit belt parallel next to each other and collectively further treated in one or more treatment steps. For this purpose the same non-woven properties can be created in each of the non-woven webs.

In a separate after-treatment of the non-woven web it is possible to produce non-woven materials having different properties in one production system. For this purpose the non-woven webs are discharged from the deposit belt, and separately after-treated in one or more treatment steps. Each of the treatment steps of the non-woven web can be individually adjusted to the respectively desired properties of the finished non-woven material.

For the after-treatment, the non-woven webs preferably are initially reinforced after leaving the deposit belt, and then wound to a sleeve. However, it is also possible to carry out further treatment steps between the reinforcing and winding.

In order to obtain a filament structure within the non-woven web that is as uniform as possible, the method variation is particularly advantageous, in which the filaments are extruded through multiple nozzle plates arranged next to each other, having a plurality of nozzle bores, wherein the filaments extruded through a nozzle plate form one of the filament groups. In this manner the nozzle plates are substantially adjusted to the production widths of the non-woven webs in order to facilitate the handling of the nozzle plates.

The nozzle plates may also be held by a spinning beam, or by means of multiple spinning beams arranged next to each other. In an arrangement of the nozzle plates of multiple spinning beams it is also possible to partially maintain the production of the non-woven webs at least during maintenance work. For this purpose, for example, one of the spinning beams, the nozzle plate of which is to be serviced, can be locked from the melt supply such that the production of the non-woven material can be continued using the adjacent spinning beam.

For the production of a non-woven material, the spinning beams are preferably connected to a melt source supplying one type of a polymer melt each. However, the flexibility during the production of the non-woven material can also be expanded in that the spinning beams are supplied with polymer melts by means of multiple melt sources so that non-woven webs can be produced using different types of polymer.

In order to carry out the method according to certain embodiments of the invention, the device includes extrusion means and pull-off means in such an arrangement above the deposit belt so that the filaments of the filament groups are deposited next to each other into separate non-woven webs, and that the non-woven webs are guided parallel next to each other.

The distance between adjacent non-woven webs is within a range of 0.1 m to 0.4 m such that a reciprocal influencing of the non-woven webs on the deposit belt, or on the filament guide, respectively, is impossible.

The extrusion means preferably have an elongated extension in order to place each of the filament groups allocated by the extruded filaments into a non-woven web on the deposit belt, taking up a production width within a range of 2 m to 6 m. In this manner the distribution of the filaments predetermined by the extrusion means is evenly distributed across the production width of the non-woven web.

According to an advantageous further improvement of the device, multiple treatment units are connected downstream of the deposit belt going to a collective or separate after-treatment of the non-woven web.

The treatment units include at least one reinforcement unit and one winding unit, wherein the non-woven webs are reinforced and collectively wound depending on the requirements. However, it is also possible to embody the treatment units such that the non-woven webs are each separately reinforced, and separately wound. In this manner different non-woven qualities can be produced in the non-woven webs.

According to a particularly preferred embodiment of the device, the extrusion means are formed by means of multiple nozzle plates held next to each other, each having a plurality of nozzle bores, wherein the nozzle bores are preferably held in an arrangement in a row in the nozzle plate. In this manner a high density and uniformity can be produced across a production width defining the non-woven web.

For this purpose the nozzle plates can be held by a spinning beam in the manner of rows, or by means of separate spinning beams arranged next to each other. In the arrangement in one spinning beam, the nozzle plates are preferably used in order to extrude the extruded filaments of the filament groups from one polymer melt. In the arrangement of the nozzle plates in multiple separate spinning beams, however, it is also possible to produce the filaments associated with the nozzle plates from different polymer melts. For this purpose the spinning beams are preferably supplied by multiple melt sources.

In order to obtain a uniform distribution of the polymer melt in nozzle plates that are as long as possible, while maintaining retention times that are as constant as possible, multiple dosing pumps are associated with one of the spinning beams each for the melt supply, wherein the spinning beam has a segment-like distribution direction connected upstream of the nozzle plate. For this purpose the production width of the non-woven web can be varied within the filament group via dosing pumps by means of switching individual segments on and off. The same provides further flexibility during the production of non-woven materials and non-woven webs having different production widths.

### BRIEF DESCRIPTION OF THE DRAWINGS

The techniques according to the invention are explained in further detail based on some example embodiments of devices for carrying out methods, making reference to the attached figures, as follows.

They show:

FIG. 1 a schematic view of a first example embodiment of the device according to the invention

FIG. 2 a schematic top view of a further example embodiment of the device according to the invention

FIG. 3 a schematic top view of a further example embodiment of the device according to the invention

FIG. 4 a schematic cross-section of a further example embodiment of a device according to the invention

FIG. 5 a schematic cross-section of a further example embodiment of the device according to the invention

FIG. 6 a schematic side view of a further example embodiment of the device according to the invention

FIG. 7 a schematic top view of the example embodiment of FIG. 6

### DETAILED DESCRIPTION

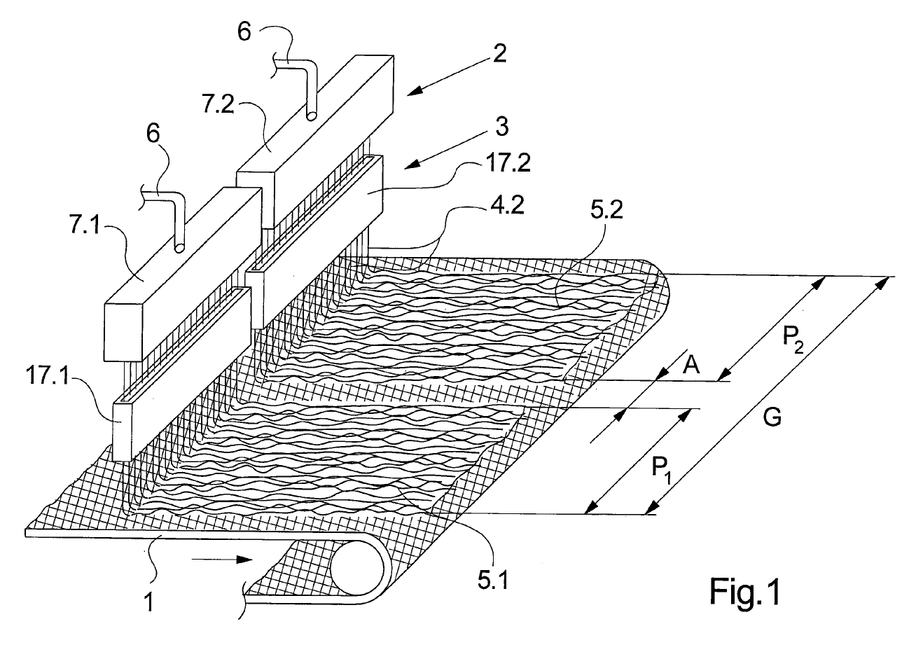

FIG. 1 shows a schematic view of a first example embodiment of a device for carrying out a method.

The example embodiment of the device according to the invention includes a deposit belt 1, being formed of a gas impermeable material, and which is driven in the direction of the arrow at a uniform guide speed. The extrusion means 2 and the pull-off means 3 are arranged above the deposit belt 1 such that a plurality of filaments are guided in filament groups 4.1 and 4.2 being embodied next to each other in rows to a non-woven web 5.1 and 5.2 onto the deposit belt 1. The extrusion means 2 are also formed by two spinning beams 7.1 and 7.2, each being connected to a melt source (not illustrated) via a melt supply 6. The spinning beams 7.1 and 7.2 have a plurality of nozzle bores at the bases thereof in order to extrude the filaments of the filament groups 4.1 and 4.2 from one polymer melt.

The pull-off means 3 is formed by means of two pull-off nozzles 17.1 and 17.2 arranged next to each other in rows at a distance to the extrusion means 2. A cooling section is provided between the spinning beams 7.1 and 7.2 and the pull-off nozzles 17.1 ad 17.2 for cooling the freshly extruded filaments. The pull-off nozzles 17.1 and 17.2 are each connected to a compressed air source (not illustrated) in order to pull off the filaments of the filament groups 4.1 and 4.2 from the spinning area and to convey the same in the direction of the deposit belt 1. For this purpose the filament group 4.1 is guided through the pull-off nozzle 17.1. The filament group 4.2 is guided through the pull-off nozzle 17.2 to the non-woven web 5.2.

The non-woven webs 5.1 and 5.2 are formed next to each other on the deposit belt 1 and discharged in the direction of the arrow by the deposit belt 1. A distance A is formed between the non-woven webs 5.1 and 5.2, which is preferably within a region of 0.1 m to 0.4 m, particularly between 0.2 m and 0.3 m. A gap is formed on the deposit belt 1 by means of the distance A between the non-woven webs 5.1 and 5.2 such that any contact between the non-woven webs 5.1 and 5.2 is excluded. The non-woven webs 5.1 and 5.2 each have a production width denoted in FIG. 1 by the code letters P1 and P2. The non-woven web 5.1 has the production width P1, and the non-woven web 5.2 has the production width P2. The production widths P1 and P2 of the non-woven webs 5.1 and 5.2 are preferably embodied equally. However, it is also possible to embody the production width of the non-woven webs 5.1 and 5.2 with different widths.

Accordingly, a total production width denoted by the code letter G in FIG. 1 is obtained for the production of the non-woven material. The total production width G is therefore the product of the sum of the production widths of the non-woven webs 5.1 and 5.2, P1 and P2, and the distance A.

The extrusion means 2 and the pull-off means 3 are operated in parallel under preferably the same operating conditions such that each of the non-woven webs 5.1 and 5.2 has the same non-woven properties.

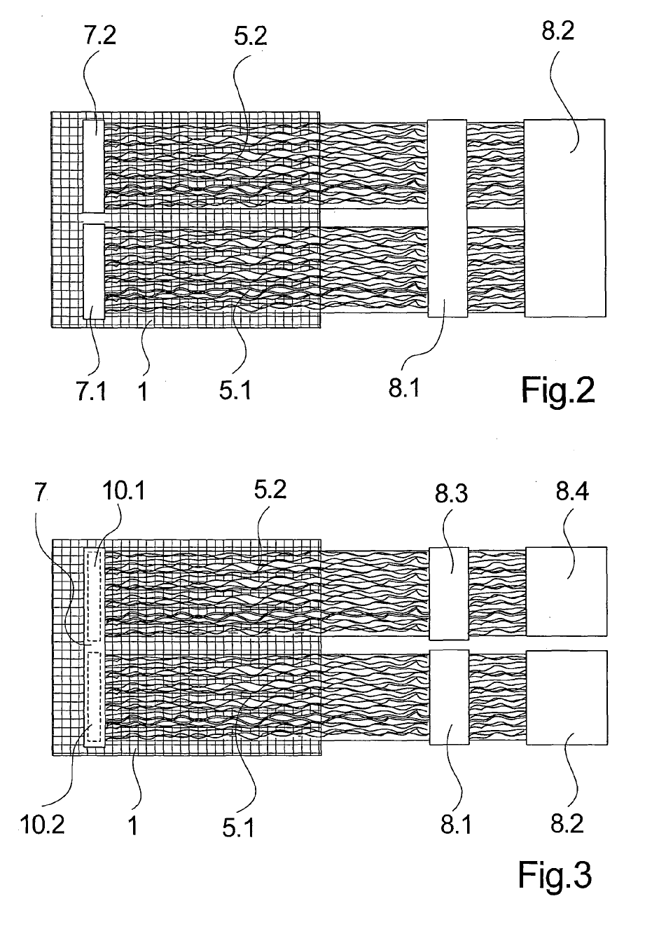

A further example embodiment of the device according to the invention for carrying out the method is schematically illustrated in FIG. 2.

For this purpose a schematic top view is shown, in which the non-woven deposit and the after-treatment of the non-woven material is illustrated.

The non-woven deposit is substantially identical to the example embodiment according to FIG. 1 such that reference is made to the previously mentioned description at this point, and only the differences are explained. The non-woven webs 5.1 and 5.2 guided on the deposit belt 1 are collectively discharged by means of the drive of the deposit belt, and are subsequently guided to multiple treatment units. For this purpose two successively provided treatment units 8.1 and 8.2 are shown by way of example. After leaving the deposit belt 1 the non-woven webs 5.1 and 5.2 are successively and collectively guided to the treatment units 8.1 and 8.2 in order to be treated collectively and simultaneously. For this purpose the treatment may be, for example, the reinforcing of the fiber bond within the non-woven web. A distance is maintained between the non-woven webs 5.1 and 5.2 during the after-treatment such that a substantially parallel run of the non-woven webs 5.1 and 5.2 is ensured.

A further example embodiment of the device according to the invention for carrying out the method is illustrated in FIG. 3. The example embodiment according to FIG. 3 is substantially identical to the example embodiment according to FIG. 2 such that reference is made to the previously mentioned description at this point, and only the differences are explained.

In the example embodiment shown in FIG. 3 the non-woven webs 5.1 and 5.2 are extruded by means of one spinning beam 7 having extrusion means embodied in the form of two nozzle plates. For this purpose the nozzle plates 10.1 and 10.2 are held at the base of the spinning beam 7. Such an extrusion means is described in further detail below so that no further explanations are provided at this point.

For the after-treatment of the non-woven webs 5.1 and 5.2 separate treatment units are associated with each of the non-woven webs 5.1 and 5.2. In this manner the non-woven web 5.1 is treated in the successively arranged treatment units 8.1 and 8.2. The non-woven web 5.2 is treated by the treatment units 8.3 and 8.4. For this purpose the treatment units 8.1 and 8.3 and the treatment units 8.2 and 8.4 may be embodied identically such that, for example, reinforcement is carried out in one of the first treatment steps, and winding is carried out in a second treatment step. However, it is also possible that the treatments in the treatment units 8.1 and 8.3 and in the treatment units 8.2 and 8.4 are embodied and carried out differently on the non-woven webs 5.1 and 5.2. In this manner each of the non-woven webs 5.1 and 5.2 can be treated individually such that a non-woven material can be produced having different properties.

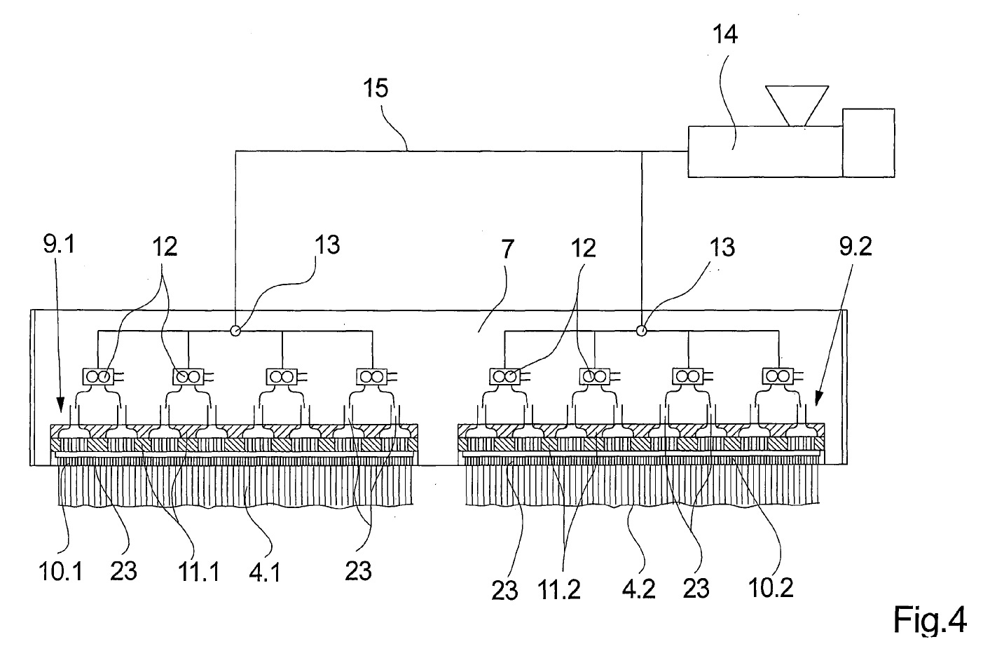

An extrusion means is schematically illustrated in FIG. 4, such as the same could be used, for example, for extruding the filament groups in the example embodiment according to FIG. 3. The extrusion means is formed by a spinning beam 7. Two nozzle sets 9.1 and 9.2 arranged next to each other are held within the spinning beam 7 at the base thereof. Each of the nozzle sets 9.1 and 9.2 is connected to a melt source 14 via a plurality of dosing pumps 12 and multiple melt distributors 13. By way of example an extruder is shown as the melt source 14, wherein a plastic granulate is melted into a polymer melt.

The nozzle sets 9.1 and 9.2 are each held at the base of the heated spinning beam 7 and are formed by multiple plates. The nozzle sets 9.1 and 9.2 each have a nozzle plate 10.1 and 10.2 at the base, including a plurality of nozzle bores 23, from which the filaments of the filament groups 4.1 and 4.2 are extruded. The nozzle bores 23 are held in the nozzle plates 10.1 and 10.2 in a row-like arrangement such that the extruded filaments form a filament curtain. A distribution plate system 11.1 and 11.2 is connected upstream of each of the nozzle plates 10.1 and 10.2, which has a plurality of melt inlets 23 connected to the nozzle bores of the nozzle plate 10.1 and 10.2 by means of segmented distribution spaces.

The example embodiment of the extrusion means illustrated in FIG. 4 is particularly suited to uniformly extrude a plurality of filaments within a large production width. A melt supply across all nozzle bores is achieved via the plurality of the dosing pumps and the segmented distribution of the melt such that each of the filaments is extruded at high consistency within the filament groups 4.1 and 4.2.

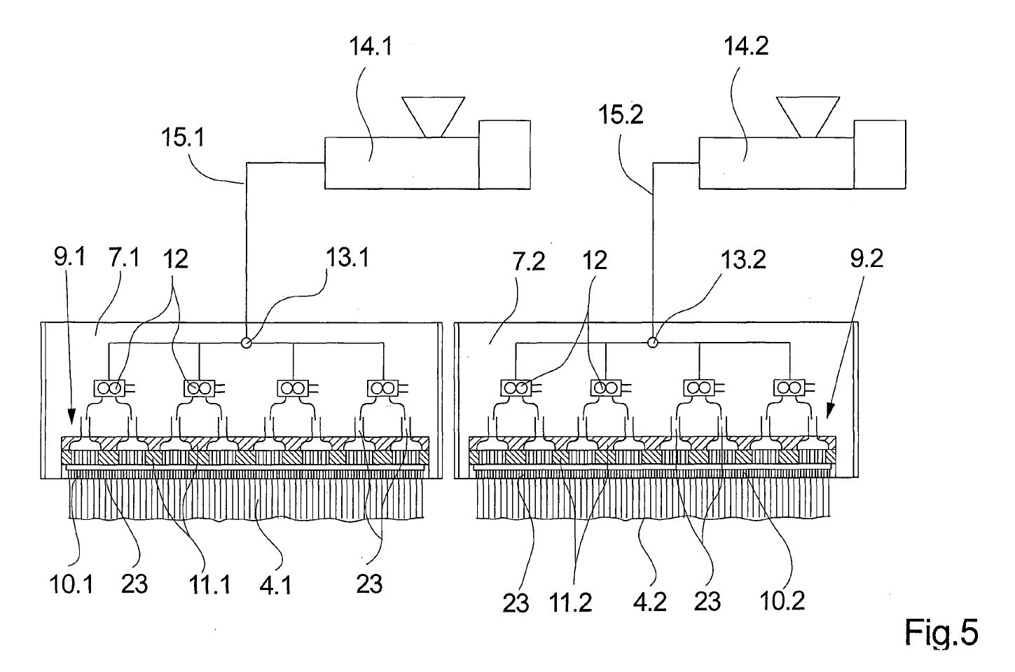

FIG. 5 illustrates a further example embodiment of an extrusion means, such as could be utilized in the embodiments according to FIG. 1 or 2, for example.

The example embodiment illustrated in FIG. 5 is substantially identical to the example embodiment according to FIG. 4 so that reference is made to the previously mentioned description at this point, and only the differences are explained below.

In the arrangement of the extrusion means illustrated in FIG. 5 the nozzle sets 9.1 and 9.2 are each held by separate spinning beams 7.1 and 7.2. The dosing pumps 12 and the melt distributors 13.1 and 13.2 associated with the nozzle sets 9.1 and 9.2 are arranged within the spinning beams 7.1 and 7.2. For this purpose the spinning beam 7.1 is connected to the melt source 14.1 via the melt distributor 13.1 and the melt line 15.1. The dosing pumps 12 in the spinning beam 7.2 are supplied with a polymer melt by the melt source 14.2 via the melt distributor 13.2 and the melt line 15.2. In this regard two filament groups 4.1 and 4.2 differing in the polymer composition thereof can be produced by means of the spinning beams 7.1 and 7.2. A high degree of flexibility during the production of non-woven materials, particularly in large-scale systems, can be achieved in this manner.

However, it is generally also possible to supply the dosing pumps 12 within both spinning beams 7.1 and 7.2 with a single melt source—as shown in FIG. 4—such that both filament groups 4.1 and 4.2 are extruded by filaments of the same composition.

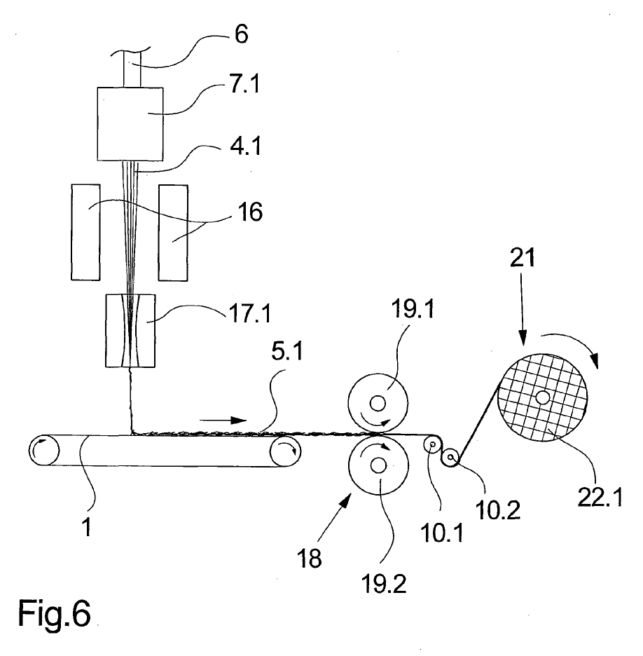

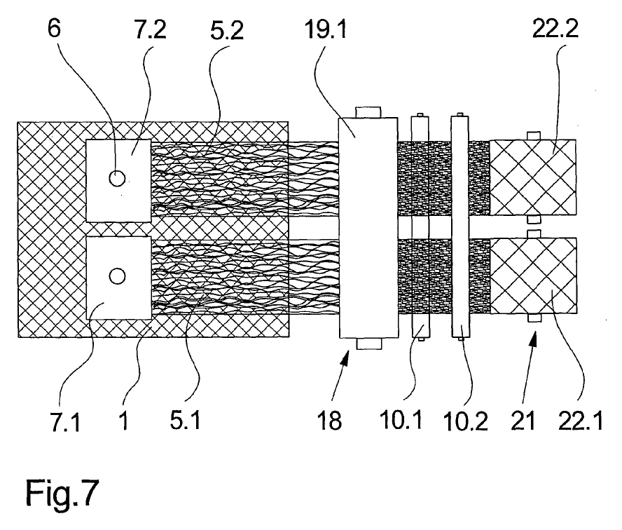

A further example embodiment of a device according to the invention for carrying out the method is illustrated in FIGS. 6 and 7, wherein the non-woven webs 5.1 and 5.2 are wound to sleeves during the final step of an after-treatment. The example embodiment is shown in FIG. 6 in a schematic side view, and in a top view in FIG. 7. The following description applies to both figures insofar as no reference is made to any one of the figures.

For the extrusion of the filament groups 4.1 and 4.2, two spinning beams 7.1 and 7.2 arranged in a row are provided, as have been described above, for example. The spinning beams 7.1 and 7.2 are connected to a melt source via melt supplies 6. A blowing device 16 is provided below the spinning beams 7.1 and 7.2, by means of which a cool air flow directed transversely onto the filament strands is created. For this purpose the blowing device 16 extends across the entire width of the filament groups 4.1 and 4.2. Two pull-off nozzles 17.1 and 17.2 are provided below the blowing device 16 as pull-off means, by means of which the filaments of the filament groups 4.1 and 4.2 are pulled off and conveyed onto the deposit belt 1. The non-woven webs 5.1 and 5.2 are formed on the surface of the deposit belt 1 by means of depositing the filament groups 4.1 and 4.2. The non-woven webs 5.1 and 5.2 are uniformly guided in the direction of the arrow by the deposit belt 1 for after-treatment.

A reinforcement unit 18 is associated with the deposit belt 1 on the discharge side. The reinforcement unit 18 has two calender rollers 19.1 and 19.2 substantially extending across the entire production width. The non-woven webs 5.1 and 5.2 are guided by the nip formed between the calender rollers 19.1 and 19.2 for reinforcement.

The guide rollers 10.1 and 10.2 are provided on the discharge side of the calender rollers 19.1 and 19.2 in order to feed the non-woven webs 5.1 and 5.2 to the winding unit 21 at a preferably uniform tension. The non-woven webs 5.1 and 5.2 are each wound into separate sleeves 22.1 and 22.2 in the winding unit 21. For this purpose the sleeves 22.1 and 22.2 are collectively driven via a spindle. For this purpose the sleeves 22.1 and 22.2 can be wound both on separate winding carriers and on a mutual winding carrier. The example embodiment shown in FIGS. 6 and 7 is therefore suitable in order to produce, for example, two non-woven webs parallel next to each other, wherein each of the non-woven webs has a production width of, for example, five meters.

In the previously shown example embodiments the amount of the simultaneously and parallel produced non-woven webs is illustrated by way of example. However, the method and the device according to certain embodiments of the invention are generally not limited to a certain amount of simultaneously produced non-woven webs. For example, three, four, or even more non-woven webs can be produced parallel next to each other on one deposit. Furthermore, certain embodiments also include such solutions, in which the deposit belt is embodied by a deposit drum or other continuous deposit means. The method and the device according to certain embodiments of the invention are particularly suited in order to be able to produce non-woven materials at a high production output. In this manner total production widths of up to 10 m and more are possible, wherein one non-woven material can be produced within the entire production width at a high degree of uniformity. However, the entire production width can also be utilized in order to simultaneously produce non-woven materials with different properties within the total production width.

### LIST OF REFERENCE SYMBOLS

1 deposit belt
2 extrusion means
3 pull-off means
4.1, 4.2 filament groups
5.1, 5.2 non-woven web
6 melt supply
7, 7.1, 7.2 spinning beam
8.1, 8.2, 8.3, 8.4 treatment unit
9.1, 9.2 nozzle set
10.1, 10.2 nozzle plate
11.1, 11.2 distributor plate system
12 dosing pump
13, 13.1, 13.2 melt distributor
14, 14.1, 14.2 melt source
15.1, 15.2 melt line
16 blowing device
17, 17.1, 17.2 pull-off nozzle
18 reinforcement unit
19.1, 19.2 calender rollers
20.1, 20.2 guide roller
21 winding unit
22.1, 22.2 sleeve
23 nozzle bore

What is claimed is:

1. A method for melt spinning and depositing synthetic filaments into a non-woven material, in which the synthetic filaments are simultaneously extruded next to each other in multiple filament groups and pulled off, and wherein the filaments of the filament groups are collectively deposited on a deposit belt, wherein the filaments of the filament groups are deposited next to each other into separate non-woven webs, and wherein the non-woven webs are guided parallel next to each other.

2. The method according to claim 1, wherein the non-woven webs are placed and guided next to each other on the deposit belt at a distance.

3. The method according to claim 1, wherein a non-woven web is placed on the deposit belt by means of the filaments of a filament group and takes up a production width in a range of 2 m to 6 m.

4. The method according to claim 1, wherein the non-woven webs are collectively discharged from the deposit belt, and are collectively subjected to an after-treatment.

5. The method according to claim 1, wherein the non-woven webs are collectively discharged from the deposit belt, and are separately subjected to an after-treatment.

6. The method according to claim 5, wherein the non-woven webs are reinforced and wound for after-treatment.

7. The method according to claim 1, wherein the filaments are extruded through multiple nozzle plates arranged next to each other, having a plurality of nozzle bores, wherein the filaments extruded through a nozzle plate form one of the filament groups.

8. The method according to claim 7, wherein the nozzle plates are held by one spinning beam, or by multiple spinning beams arranged next to each other.

9. The method according to claim 7, wherein the spinning beams are supplied with a polymer melt collectively by one melt source, or separately with multiple polymer melts by multiple melt sources.

10. A device to melt spin and deposit synthetic filaments into a non-woven material, the device comprising extrusion means for the extrusion of a plurality of filaments into multiple filament groups, having pull-off means for pulling off and depositing the filaments of the filament groups, and having a deposit belt for receiving the filaments, wherein the extrusion means and the pull-off means are arranged above the deposit belt such that the filaments of the filament groups are deposited next to each other on the deposit belt into separate non-woven webs, and that the non-woven webs are guided parallel next to each other.

11. The device according to claim 10, wherein a distance (A) is embodied in the range of 0.1 m to 0.4 m between adjacent non-woven webs on the deposit belt.

12. The device according to claim 10, wherein the extrusion means each have an elongated extension, that the non-woven web placed on the deposit belt by means of the extruded filaments of the associated filament group takes up a production width in the range of 2 m to 6 m.

13. The device according to claim 10, wherein multiple treatment units are connected downstream of the deposit belt for a collective or separate after-treatment of the non-woven webs.

14. The device according to claim 13, wherein the treatment units have a reinforcement unit for the collective or separate reinforcement of the non-woven webs, and a winding unit for the collective or separate winding of the non-woven webs.

15. The device according to claim 10, wherein the extrusion means are embodied by means of multiple nozzle plates that are held next to each other, each having a plurality of nozzle bores, wherein the nozzle bores are preferably contained in the nozzle plate in a row-shaped arrangement.

16. The device according to claim 15, wherein the nozzle plates are held in rows by means of one spinning beam or by means of multiple spinning beams.

17. The device according to claim 15, wherein the spinning beams are connected to one melt source, or separately to multiple melt sources.

18. The device according to claim 15, wherein multiple dosing pumps are each associated with one of the spinning beams for the melt supply, wherein the spinning beam has a segment distributor unit connected upstream of the nozzle plate.

19. A method for melt spinning and depositing synthetic filaments into a non-woven material, the method comprising:
simultaneously extruding and pulling off the synthetic filaments next to each other in multiple filament groups;
collectively depositing the filament groups on a deposit belt, the filaments of the filament groups being deposited next to each other to form separate non-woven webs; and
guiding the non-woven webs next to and parallel to each other on the deposit belt.

20. The method according to claim 19, wherein an extruder and pull-off mechanism are disposed above the deposit belt; and wherein collectively depositing the filament groups on the deposit belt includes:
laying the filaments of the filament groups on the deposit belt in a manner in which a distance between adjacent non-woven webs is within a range of 0.1 m to 0.4 m, while reciprocal influencing of the adjacent non-woven webs on the deposit belt is inhibited.
